(19) United States
(12) Patent Application Publication
(10) Pub. No.: US 2005/0135531 A1
(43) Pub. Date: Jun. 23, 2005

(54) Nuclear fusion reactor and method to provide temperature and pressure to start nuclear fusion reactions

(76) Inventor: Ulrich Augustin, Blythewood, SC (US)

Correspondence Address: GREENBLUM & BERNSTEIN, P.L.C., 1950 ROLAND CLARKE PLACE, RESTON, VA, 20191, US

(21) Appl. No.: 10/690,539

(22) Filed: Oct. 23, 2003

(51) Int. Cl. G21B 1/00

(52) U.S. Cl. 376/100

(57) ABSTRACT

A fusion reactor assembly which generates a fusion reaction and a method of use. The assembly includes a substantially spherical body adapted to contain working fluid in a working space which is closed to ambient. At least one actuator is contained by the substantially spherical body to generate at least one pressure wave in the working fluid. A mechanism is provided for amplifying the at least one pressure wave in the working fluid such that an amplified pressure wave deforms the actuator to generate electrical energy.

### BACKGROUND OF THE INVENTION

1. Field of the Invention

The invention generally relates to nuclear fusion reactors and, more particularly, a structure and method for providing a temperature and pressure to start nuclear fusion reactions.

2. Background Description

Fusion power offers the prospect of an almost inexhaustible source of energy for future generations, but it also presents so far insurmountable scientific and engineering challenges. With current technology, the reaction most readily feasible is between the nuclei of the two heavy forms (isotopes) of hydrogen, e.g., deuterium (D) and tritium (T). In these cases, each D-T fusion event releases approximately 17.6 MeV.

Deuterium occurs naturally in seawater, which makes it very abundant relative to other energy resources. Tritium, however, does not occur naturally and is radioactive, with a half-life of about 12 years. Tritium can be made in a conventional nuclear reactor, or bred in a fusion system from lithium. Lithium, as is known, is found in large quantities in the Earth's crust and is thus a readily available source.

At present, two different experimental approaches are being studied; however, these experimental approaches need more input energy than which is generated as output energy. For example, these approaches are fusion energy by magnetic confinement (MFE) and fusion by inertial confinement (ICF). MFE uses strong magnetic fields to trap the hot plasma and ICF involves compressing a hydrogen pellet by smashing it with strong lasers or particle beams.

In MFE, D-T plasma at a density of less than a milligram per cubic meter are confined by a magnetic field at a few atmospheres pressure and heated to fusion temperature. The aim is to prevent the particles from coming into contact with the reactor walls as this will dissipate their heat and slow them down. The most effective magnetic configuration is a toroidal shaped form. In a tokamak reactor, for example, the toroidal field is created by a series of coils evenly spaced around a torus-shaped reactor, and the poloidal field is created by a strong electric current flowing through the plasma. In a stellarator, for example, the helical lines of force are produced by a series of coils which may themselves be helical in shape.

In stellarators, these heating systems have to supply all the energy needed. In tokamaks and reversed field pinch (RFP) devices, the current flowing through the plasma also serves to heat it to a temperature of about 10 million degrees Celsius. Beyond that, additional heating systems are needed to achieve the temperatures necessary for fusion. In a tokamak, the toroidal field is created by a series of coils evenly spaced around the torus-shaped reactor, and the poloidal field is created by a strong electric current flowing through the plasma. RFP devices have the same toroidal and poloidal components as a tokamak, but the current flowing through the plasma is much stronger and the direction of the toroidal field within the plasma is reversed.

Tokamaks operate within limited parameters outside which sudden losses of energy confinement (disruptions) can occur, causing major thermal and mechanical stresses to the structure and walls. Nevertheless, it was considered so far the most promising design, and research is continuing on various tokamaks around the world, the two largest being the Joint European Torus (JET) in the UK and the tokamak fusion test reactor (TFTR) at Princeton in the USA.

Research is also being carried out on several types of stellarator. The biggest of these, the Large Helical Device at Japan's National Institute of Fusion Research, began operating in 1998. It is being used to study of the best magnetic configuration for plasma confinement.

In Inertial confinement (ICF), which is a newer line of research, laser or ion beams are focused very precisely onto the surface of a target, which is a sphere of D-T ice, a few millimeters in diameter. This evaporates or ionizes the outer layer of the material to form a plasma crown, which expands generating an inward-moving compression front, or implosion, which heats up the inner layers of material. The core or central hot spot of the fuel may be compressed to one thousand times its liquid density, and ignition occurs when the core temperature reaches about 100 million degrees Celsius. Thermonuclear combustion then spreads rapidly through the compressed fuel, producing several times more energy than was originally used to bombard the capsule. The time required for these reactions to occur is limited by the inertia of the fuel (hence the name), but is less than a microsecond. The aim is to produce repeated micro explosions.

In any case, the energy need for these systems far outweigh the output energy. This, of course, is inefficient and is not thus very cost effective.

### SUMMARY OF THE INVENTION

In a first aspect, a fusion reactor assembly includes a substantially spherical body adapted to contain working fluid in a working space which is closed to ambient and at least one actuator contained by the substantially spherical body to generate at least one pressure wave in the working fluid. A means for amplifying the at least one pressure wave in the working fluid is provided such that an amplified pressure wave deforms the actuator to generate electrical energy.

In embodiments, the amplifying means includes at least one deuterium-tritium gas bubble compressed by the pressure wave to generate the amplified pressure wave. The amplifying means may generate a negative pressure wave compared to residual pressure to generate deuterium-tritium gas bubbles in a center of the working space. The amplifying means may include gas bubbles in a center of the working space provided by one or more inlet tube located in a radial arrangement to the working space which are compressed by the pressure wave. The fusion reactor may further include a control and power unit activating the at least one actuator to generate the at least one pressure wave in the working fluid; and a conditioning system providing stable pressure and temperature conditions of the working fluid. The control and power unit uses one or more pressure sensors, a pressure pump and an external reservoir to control residual pressure of the working fluid within the working space. The control and power unit may use one ore more temperature sensors, a secondary fluid circuit with a pump, a heat exchanger and the conditioner to control the temperature of the working fluid within the working space.

In another aspect of the invention, the fusion reactor assembly includes a substantially spherical body having an inner wall and an outer wall. The inner wall is adapted to contain working fluid in a working space which is closed to ambient. At least one actuator is contained between the inner wall and the outer wall and generates at least one pressure wave in the working fluid. A control and power unit activates the at least one actuator to generate the at least one pressure wave in the working fluid and a conditioning system provides stable pressure and temperature conditions of the working fluid. A means supplies a gas bubble into the center of the substantially spherical body which intersects with the at least one pressure wave. The at least one pressure wave compresses the gas bubble which, in turn, amplifies the at least one pressure wave, and the amplified pressure wave reflects on the inner wall and deforms the actuator to generate electrical energy.

In another aspect, a method provides a fusion reaction in a substantially spherical body closed to ambient to generate electricity. The method includes providing a working fluid and a gas bubble in the working fluid. A pressure wave is generated in the working fluid that intersects with the gas bubble. The gas bubble is compressed with the pressure wave to increase a temperature and pressure of the gas bubble creating a thermal reaction and triggering a fusion reaction of material comprising the gas bubble. The pressure wave is amplified which then deforms an actuator material to generate electricity.

### BRIEF DESCRIPTION OF THE DRAWINGS

FIG. 1 is a schematic of the fusion reactor and the principal controlling components in accordance with the invention.

FIG. 2 is a cross section of the spherical working space of the invention.

FIG. 3 is a graph showing the amplitude of a pressure wave within the working space, depending on the location of the wave in accordance with the invention.

FIG. 4 is a schematic cross section of the working space showing the different layers of the body using piezo actuators in accordance with the invention.

FIG. 5 is a detailed cross section view of a segmented piezo actuator layer of the body in accordance with the invention.

FIG. 6 is a top view of the piezo actuator segments in accordance with the invention.

FIG. 7 is a schematic cross section of a magnetostrictive actuator element in accordance with the invention.

FIG. 8 is a schematic cross section of a solenoid actuator element in accordance with the invention.

FIG. 9 is a graph showing the negative amplitude of a pressure wave depending on the location within the working space in accordance with the invention.

FIG. 10 is a graph showing a pressure wave versus time generated on the wall of the working space in accordance with the invention.

FIG. 11 is a graph showing a pressure wave in two different locations of the working space in accordance with the invention.

FIG. 12 is a graph showing deformations of pressure waves in different locations of the working space in accordance with the invention.

FIG. 13 is a graph showing a deformed wave after run time and an actuator generated wave to correct this wave in accordance with the invention.

FIG. 14 is a schematic cross section of the working space including a mechanism to provide gas bubbles in the center of the working space in accordance with the invention.

FIG. 15 is a detailed cross section of the center of the working space having a mechanism to provide a jet stream with gas bubbles in accordance with the invention.

FIG. 16 is a schematic cross section of the working space including hydraulic elements to adjust the outer shape of the outer wall in accordance with the invention.

FIG. 17 is a schematic cross section of the working space where the actuator is segmented and the segments are separately controlled in accordance with the invention.

### DETAILED DESCRIPTION OF EMBODIMENTS OF THE INVENTION

This invention is directed to a nuclear fusion system and an electronic control system to provide ignition conditions for deuterium tritium fusions. The invention generates electrical energy without the use of additional generators or thermo converters. In one implementation, a substantially spherical space filled with water or other liquids such as oil based liquids such as gasoline, water based liquids as mixtures of water and alcohol, coolant fluids and the like is closed to ambient and has on the inner wall a layer of actuators. A control unit controls the actuators to generate spherical pressure waves, like spikes. The waves are running with speed of sound from the walls to the center of the working space and from the center to the opposite wall side where they are reflected. The actuators are activated in a manner to amplify the spherical waves when they are reflected on the walls until the system is oscillating with its natural frequency, in one implementation.

In the system of the invention, the energy of a running wave is constant; that is, the energy per volume is directly dependent on the surface of the wave. In other words, the amplitude of a wave in the center of the working space goes to infinity. During this time, a device provides a steady liquid jet stream containing small gas bubbles through the center of the working space. The gas bubbles are, in one implementation, a mixture of deuterium and tritium with optional oxygen content.

Now, when a high pressure wave meets one or more bubbles in the center of the working space, the bubble becomes compressed and the temperature as well as the density rises in accordance with the thermodynamic laws. At the beginning of the compression, a thermal reaction will occur in case when oxygen is present. This thermal reaction may be helpful to improve the start conditions at the beginning of the compression of the bubble. The temperature and pressure at the end of the compression of the bubble are high enough to trigger a fusion reaction between deuterium and tritium. When this happens, the pressure wave running from the center of the working space to the wall of the working space becomes amplified. The pressure waves then contact the walls and hence the actuators, at which time the actuators are deformed and generate electricity. By using this system and method, more energy is released than is input into the system thus providing a viable system.

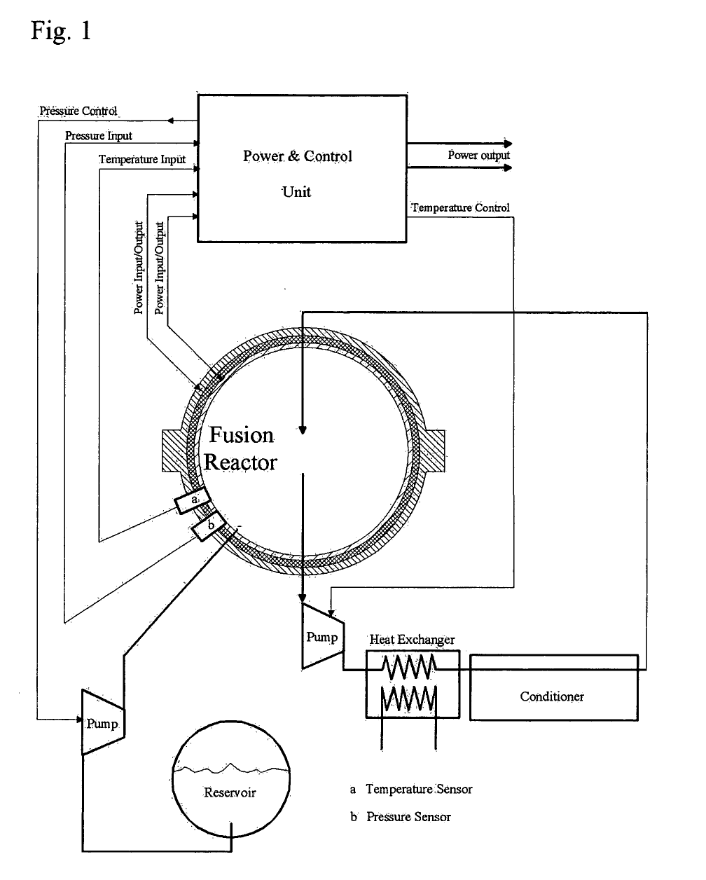

Referring to the drawings more particularly, FIG. 1 shows a spherical working space of the fusion reactor and principal components to control the fusion process. In particular, a control and power unit “C” is used to generate electrical pulses (power output) for actuators located in the wall of the working space. The control and power unit also transforms the generated electrical energy (power input) generated from the fusion reactor in a convenient form, e.g., electrical energy for common use like energy from power plants, both via power input/output lines.

The working space of the fusion reactor is filled with a pressurized working fluid, in one implementation water. The control and power unit “C” using one ore more pressure sensors “b”, a pressure pump “P₁” and an external reservoir “R” controls the residual pressure of the working fluid within the working space (for example 0.05 Mpa to 5 Mpa), via control lines (e.g., pressure control, pressure input). For example if the desired residual pressure is 1 Mpa and the pressure sensor located in the working space indicates 0.8 Mpa, the internal controller of the control unit will activate an external pressure pump until the nominal value of the residual pressure is reached.

The control and power unit “C” using one ore more temperature sensors “a”, a secondary fluid circuit with a pump “P₂”, a heat exchanger “H” and a conditioner “C₁” also controls the temperature of the working fluid within the working space (for example 350° F.). The components, such as the heat exchanger, the pumps and the conditioner, may be any well known component.

An external reservoir containing a part of the working fluid can be used as a heat exchanger with tubes inside. There is a steady through flow of cold water through the tube system. The heat of the working fluid will heat up the cold water through the walls of the tubes. Thus, the temperature of the out flowing cooling fluid (e.g., water) is higher than at the tube inlet. If the desired temperature of the working fluid is reached (measured by a temperature sensor) an internal temperature controller of the control unit will activate a valve in the cooling circuit to lower the amount of cooling fluid. In case of overheating of the working fluid, the controller will open the same valve to rise the amount of cooling flow. Any known type of heat exchanger may be implemented with the system and method of the invention.

The conditioner “C₁” is described in greater detail below. One task of the conditioner “C₁” is to provide calibrated deuterium-tritium gas bubbles or to provide a certain amount of soluble deuterium-tritium gas in the working fluid. Depending on the efficiency of the process and the size of the reactor some gas bubbles with a size of less than 1 mm are needed. (The lifetime energy consumption of an American family is about 15 grams of this kind of fuel.)

A second task of the conditioner “C₁” is to remove helium from the working fluid. After a fusion reaction, the remaining gas bubbles may contain deuterium, tritium, oxygen and helium. This gas mixture can also be in solution with the working fluid, e.g., the gas is disappeared in the molecular structure of the working fluid. The extraction of helium can be realized in different steps, in one example:
Step 1: the pressure of the working fluid is discharged to a very low level by using a vacuun pump. Then most of the gas will get out of solution what means it gets separated from the working fluid.
Step 2: the gas can be burned in a flame by adding additional oxygen and an ignition. The results (burning products) are water or heavy water from deuterium-hydrogen and tritium-oxidation and helium is only remaining; it has had no reaction with oxygen.
Step 3: the helium gas can be collected.
Step 4: the remaining heavy water-water mixture can be separated by electrolysis in oxygen and a hydrogen-tritium-deuterium-gas mixture ready for use as new unburned fuel in the fusion reactor.

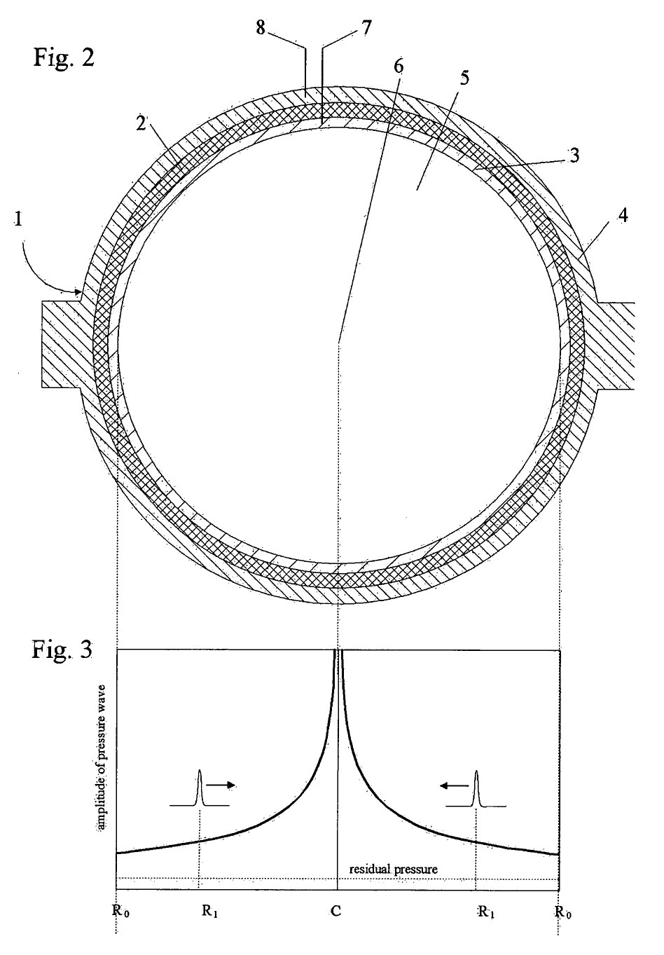

FIG. 2 shows a cross section of a fusion reactor 1 having an outer wall 4 of the working space and an inner wall 3 of the working space. Both the inner wall 3 and the outer wall 4 may, in one implementation, is made of a metallic material such as, for example, stainless steel for the inner wall and standard steel for the outer wall. Between both walls 3 and 4 is a layer of piezo material 2 acting as an actuator. In one implementation, the actuator type is a layer of piezo material 2, which requires a strong electrical field to change its shape. As one type of actuator, the piezo layer may be solid material, where between the inner wall 3 and the outer wall 4, a high tension electrical pulse is applied. The actuator has two tasks: (i) to generate pressure waves to start the process and (ii) to transform partially an incoming high-pressure wave into electrical energy. To apply an electrical field to the piezo material 2, an electrical voltage source, provided by, for example, the control and power unit “C,” is connected with an outer wall connector 8 and an inner wall connector 7. The working space with its center 6 is completely filled with a working fluid 5 (e.g., water).

The working process is started by generating a small pressure spike on the whole inner wall 3 of the spherical working space. This pressure spike occurs when the actuators 2, located between the inner wall 3 of the working space and the outer wall 4 of the working space become activated by for example, providing a voltage by the control and power unit “C”. That is, under the effect of an electrical field the length of the piezo material 2 (e.g., crystal) changes and will begin the process of generating a pressure within the working space.

For example, a 30 mm piezo layer extends for approximately 50 micrometer within a time of approximately 25 microseconds when a voltage of 30,000 Volt is applied. The needed voltage can be reduced by using piezo material 2 which, itself, is layered (for example 150 Volt and 200 layers). The short stroke of the piezo actuator 2 compresses the inner wall 3 of the working space with a speed of approximately 2 m/s, in one example. Then, the inner wall 3 compresses the working fluid (e.g., water) producing a pressure wave. On the inner wall, the pressure amplitude p of this wave can approximately calculated by using the equation of Allievi:
p=aρν
where p is the pressure, a is the sound speed, ρ. is the density of the fluid and ν is the speed of motion.

In one implementation, applied to the motion speed of 2 m/s, the amplitude of the pressure spike generated by the piezo actuator 2 is approximately 2 Mpa. This pressure wave runs simultaneously from the whole inner wall surface to the center 6 of the working space. On the way to the center 6 of the working space, the amplitude of this pressure spike becomes larger such as several million Mpa.

The energy content of this spherical pressure wave is directly dependent on its surface; that is, in the center of the working space the amplitude of this pressure wave theoretically goes to infinitive. In reality, though, the highest pressure in the center of the working space depends on surface qualities of the inner wall 3, the homogeneity of the working fluid, material and properties of the piezo actuator 2, surface and structure qualities of the outer wall 4 of the working space, small local flows within the working space and external vibrations transmitted to the device, of which calculations should be known by those of ordinary skill in the art. In other words, the peak pressure is dependent on how well the wave is focused. The theoretical maximum pressure is not dependent on the size of the working space, but a larger working space is most likey less dependent on influences mentioned above. It is theorized that a working space with a diameter of 5 m will reach pressure peaks in its center of several million Mpa.

Following the way of the pressure wave after reaching the center 6, it runs back to the inner wall 3 where it has the same amplitude as at the time when it was generated. On the inner wall 3, the pressure wave is reflected and runs back to the center. Each time the pressure wave is reflected on the inner wall, it receives an additional impulse from the piezo actuator, controlled by the control and power unit. This amplifies the wave. In one implementation, the piezo actuator 2 is actuated with natural frequency or a multiplication of natural frequency of the fluid in the working space.

Now, when a small fluid stream containing small deuterium-tritium gas bubbles passes the center 6 of the working space, the pressure wave will meet the gas bubble in the center of the working space. At this juncture, the gas bubble becomes highly compressed and the temperature and density of the gas mixture rise extremely, following known laws of thermodynamics.

To improve the value of peak temperature, also a mixture of deuterium, tritium and oxygen may be used with the system of the invention, for example less than the stoichiometric quantity of oxygen. If more than the stoichiometric quantity of oxygen s is used, there will be a complete oxidation of the fuel and no gas will remain. An adequate mixture will be so much oxygen to burn half of the gas to water and the unburned and overheated gas can act as fuel for the fusion process. For example, if Hydrogen (or deuterium or tritium) reacts with oxygen in a flame the resulting product is water. However, depending on the ratio of oxygen content there are three possible scenarios:
1. Hydrogen and oxygen are in a stoichiometric quantities, then the combustion is complete and the only remaining product is water.
2. There is more oxygen than needed for a complete combustion. The result is water and a rest of unburned oxygen gas.
3. There is less oxygen than needed for a complete combustion. The result is water and a rest of unburned hydrogen gas.

In the invention, the third scenario is preferable. The combustion would help to overheat the gas bubble but there is still a overheated deuterium-tritium gas quantity acting as fuel for the fusion reaction.

In this case, oxygen and deuterium or hydrogen would have a thermo reaction at the beginning of the compression rising the start temperature. At the end of the compression of a gas bubble, the fusion of deuterium and tritium will start and heat will be released. The gas bubble now containing also helium will expand and amplify the outgoing pressure wave. When the pressure wave reaches the inner wall 3, it is larger by a known magnitude than it was when it left the wall a cycle previously. This large pressure wave compresses the wall and the piezo actuator 2 will then reflect. The compressed piezo actuator 2 then releases electrical energy which is transformed by the control and power unit in a convenient form.

FIG. 3 is a graph of the peak pressure when a wave runs from the wall R₀ to the center C. The amplitude of the wave is super positioned to the residual pressure of the working fluid. In the center of the working space the pressure of wave is rising extremely. The equations of spherical waves are:
A₍ₓ₎=A·r/rₓ
where:
A₍ₓ₎ is the amplitude of the pressure wave at the location rₓ,
rₓ is the distance to the center of the spherical space in relationship to the amplitude A at the wall, and
r is the distance of the wall to the center of the spherical space.

In other words, the amplitude of a pressure wave generated on the wall of a spherical space is rising by a factor r/rₓ. In the center of the spherical wave rₓ goes to zero and A₍ₓ₎ goes to infinity.
I₍ₓ₎=I·r²/rₓ²
where:
I₍ₓ₎ is the energy of the pressure wave at the location rₓ,
rₓ is distance to the center of the spherical space in relationship to the energy I at the wall, and
r is the distance of the wall to the center of the spherical space.

Thus, the energy is rising still stronger with the square of the distances. At the center of the spherical space the energy goes to infinity.

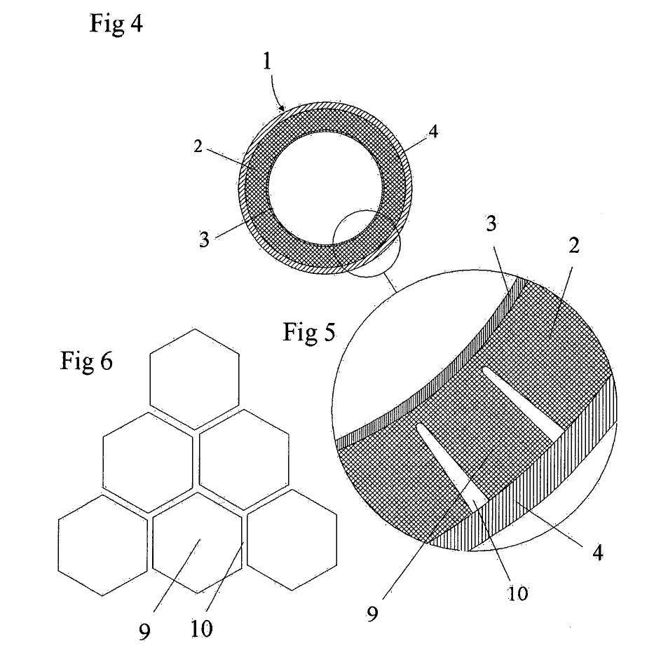

FIG. 4 is a cross section of the working space 1 with the outer wall 4, the piezo actuator 2 and an inner wall 3. FIG. 5 shows a magnified cross section of the wall structure of FIG. 4. In this aspect, the outer wall 4, which is also acting as housing of the whole assembly, has a rigid structure to prevent deformations from stress. In one example, the pressure waves reaching the inner wall have a peak pressure between 1 to 5 Mpa. In case of a working space with a diameter of 2 meters, for example, the outer wall will not overstressed by using normal steel and a thickness of 0.1 m. But, this is one example, and others are also contemplated by the invention. For example, the wall thickness “S” can be calculated by using the Lame equation:
S=(D·P)/(4·□)
where D is the diameter of the spherical space, P is the maximal pressure at the wall and □ is the maximal possible tension of the material. The thickness of the piezo layer may be 0.03 m and the thickness of the inner wall may be 1 mm. The inner wall thickness is basically used for sealing of the working fluid against the piezo material.

The outer wall also supports the piezo actuator 2. When the piezo actuator 2 extends, the diameter of the outer wall 4 should not change very much. The maximum expected change would be about 10 to 100 microns. But, the inner wall 3 gets radial charged. For this reason, the inner wall 3 should have a small flexible wall thickness as described above.

The task of the inner wall 3 is to seal the working fluid against the piezo actuator 2 and to affect the piezo motion as least as possible. Thus, in one implementation, as shown in FIG. 5, the piezo material 2 is segmented to allow the contraction in a tangential direction. If the piezo actuator is activated it becomes longer and the same time contracts, the volume of the actuator will remain about constant. But to solve the contraction problem, the piezo actuator 2 may be segmented in segments 9 with gaps 10 between the segments.

If a piezo material is activated in an electrical field, its volume is not changing but its shape. A piece of the piezo material would get longer and slimmer. In case of the piezo material between the inner wall and the outer wall, an elongation in a radial direction is needed. To prevent stress in a tangential direction the piezo material has to be segmented. The gap can be as small as possible, it is only needed to prevent tension between two piezo elements located close together. A gap of 0.2 mm will be sufficient, in one implementation. Once the piezo material is activated the gap becomes larger, of course.

FIG. 6 is a top view of the segmented piezo actuator 2. In one implementation, the segments are hexagonal segments 9. On the outer side or perimeter, all segments 9 are separated by air gaps 10, in one implementation.

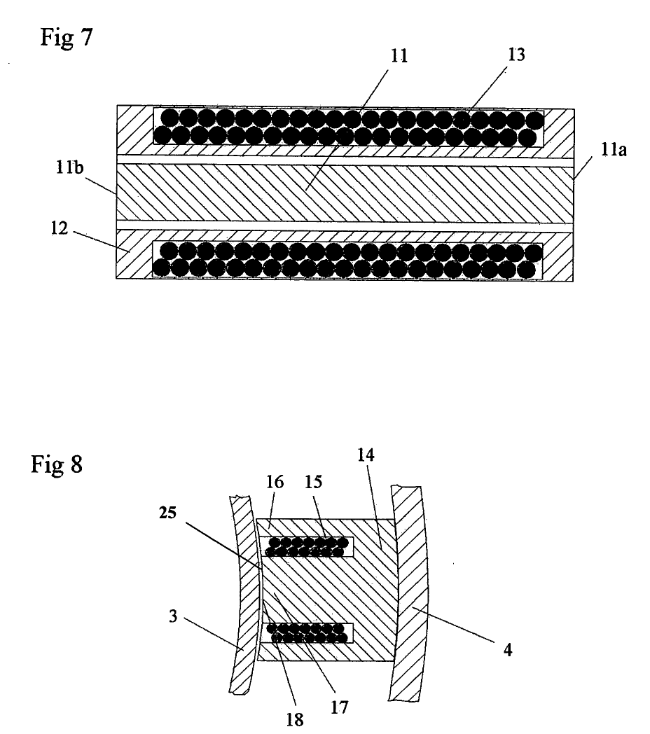

FIG. 7 shows another actuator element which can be implemented by the invention. The actuator element in this implementation is a rod 11 of magneto strictive material such as, for example, a material (TX-GMM) manufactured by Gansu Tianxing Rare Earth Functional Materials Co. Ltd. Most magnetostrictive materials are grain-oriented iron (Fe) alloys that incorporate rare earth materials such as terbium (Tb) and dysprosium (Dy). The composition and performance of the TX-GMM is similar to those of more classical magnetostrictive alloys of iron and rare earths. The stoichiometry of these materials follows the now classical pseudo-binary combination given by TbₓDy₁₋ₓFe_{2-y}. In this implementation, the rod 11 contacts the outer wall 4 with the surface 11a as well as the inner wall 3 with the surface 11b. To extend the rod 11, a magnetic field is needed, provided by coils 13 on a coil housing 12. The entire actuator for the working space is use a large number of single actuators described above, the amount which depends on the size of the spherical shape.

FIG. 8 shows an actuator element 14 using a solenoid for the piezo replacement. The solenoid 14 has an inner pole 17 and an outer pole 16 in a size of a pot, e.g., pole piece mostly with a revolved shape. Between the inner pole 17 and the outer pole 16 are the coils 15. The solenoid 14 is fixed on the outer wall 4. Between the inner pole 17 and the outer pole 16 and the inner wall 3 is a small air gap 25. The inner wall is a ferromagnetic material, for example, steel. Once applying an electrical current which activates the coil 15, a closed magnetic field flows through the solenoid 14, the inner pole 17, the inner wall 3 and the outer pole 16. Then, the solenoid pulls on the inner wall 3. When the pulling force is released, a positive pressure wave is generated and the actions described above will result. It should also be noted that the actuator solutions discussed above are but a few contemplated by the invention, and that other actuator arrangements can also be utilized by the invention, as should now be understood by those of skill reading the disclosure.

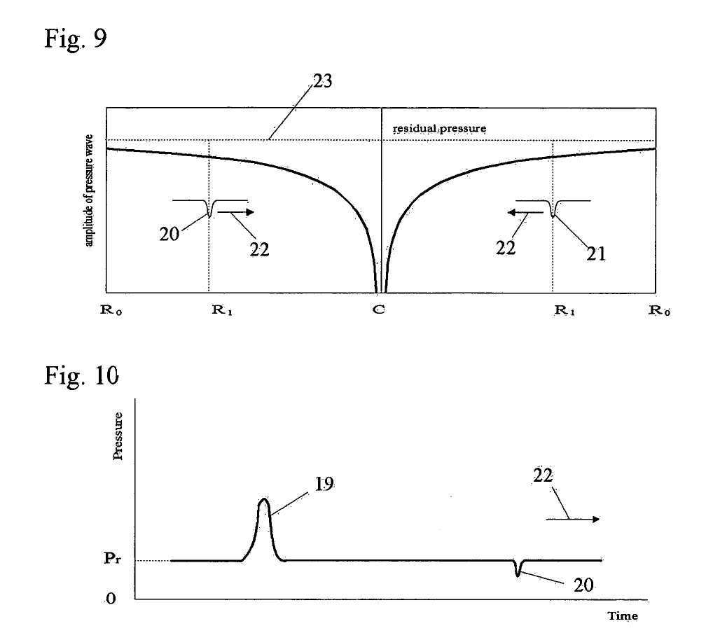

FIG. 9 shows the pressure of negative pressure waves 20 and 21 at the locations R₁, generated on the inner wall before and running into the direction 22 to the center C of the working space. Negative pressure wave refers to a working fluid on the inner wall being decompressed from residual pressure 23 to a value lower than the residual pressure. If the residual pressure is, for example, 1 Mpa, the piezo generated negative pressure wave may be 0.5 Mpa on the wall of the working space. On the way to the center of the working space, the amplitude of this pressure wave goes to zero and provides the conditions for extraction of gases of liquids. Thus, the pressure of this kind of wave will eventually reach zero when the wave is in the center of the working space.

When the pressure of a fluid is dropping from a certain value (for example residual pressure) to a very low level close to vacuum, all the gas contaminations of the fluid will immediately diffuse in a kind of gas bubble. The inverse process, to provide gas in solution when the pressure is rising, takes a long time and is dependent on the size of the surface area of the bubbles. This well known behavior of fluids and gases under the effect of pressure can be used to generate small bubbles of deuterium-tritium gas (the fuel of fusion) just on the right location as, in one implementation, controlled by the control and power unit.

FIG. 10 shows the complete pressure wave generated by the piezo actuator on the inner wall of the working space. Based on the residual pressure 23, a small negative pressure wave 20 is generated, and then a positive pressure wave 19 is generated. The wave 20 reaches the center of the working space at first generating gas bubbles. Then the positive wave 19 arrives in the center and compresses the bubbles. To prepare the best conditions for the working process, the working fluid has to be contaminated with the right amount of gas. Water, for example, as working fluid has the capabilities to dissolve a large amount of gases like deuterium, tritium and oxygen.

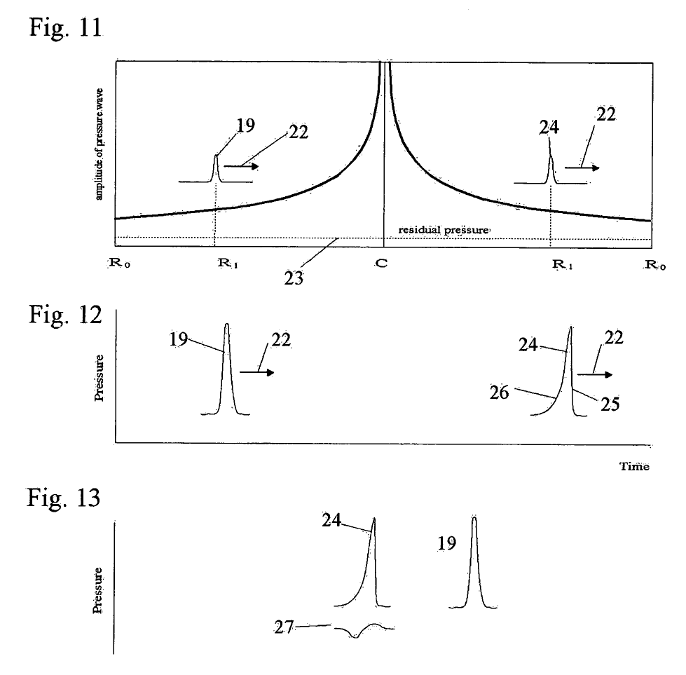

FIG. 11 shows again a pressure wave 19 at a distance R₁ from the center C and running in the direction 22 to the center. Later, the same wave, now indicated by reference numeral 24, at a distance R₁ from the center C, is running in the direction 22 to the inner wall.

FIG. 12 shows the waves 19 before and 24 after a certain runtime. After a certain runtime, the original wave shape becomes deformed. The front 25 of the wave 24 is steeper and its tail 26 is longer compared to the shape of the original wave 19. The reason for this behavior is that the speed of sound is dependent on the pressure. For example, higher pressures generate higher sound speed. Thus, the summit of a wave runs faster than the front and the tail. In the invention, where a peak shape wave is desired, waves would look after a certain number of runs (to the center and back) like sinus waves.

The speed of sound in water is approximately 1400 m in a second at ambient pressure. Thus, a wave needs about 1.42 ms to run from wall to wall of a working space that has a diameter of 2 m. On the way, the wave will change its shape and become steeper, as shown. However, the piezo actuator, with its short motion time, may have problems controlling these waves.

FIG. 13 shows a method to control the waves. When a deformed wave 24 arrives on the inner wall of the working space, the actuator generates simultaneously a pressure wave 27 to compensate for the shape of wave 19. The compensated wave 19 is identical with the original wave generated a cycle before. To generate the pressure wave 27, the control and power unit is used. As should be understood, the piezo effect is reversible which means that the piezo extends when a voltage is applied and generates voltage when it compresses (by external forces). By using these properties, the piezo acts also as a sensor. The control unit then “feels” the incoming wave and its shape such that if the shape is out of the specification, the control unit will make a correction. This may happen when a wave comes to a wall.

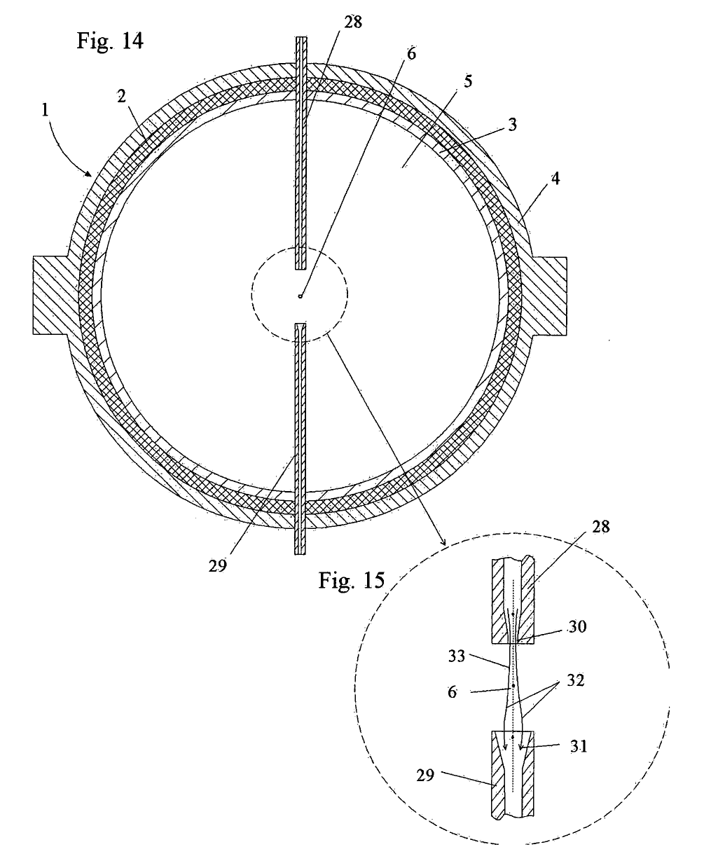

FIG. 14 shows the fusion reactor 1 with other means to provide gas bubbles in the center. In this implementation, one or more small inlet tubes 28 are located in a radial arrangement to the working space. On the opposite side, an outlet tube 29 is located. Both ends of the tubes 28 and 29 are at a safe distance to the center 6 of the working space such that the generated pressure wave will not affect the tubes. It is expected that even the strongest materials would not support the high-pressure peaks in the center of the working space. By example, in the center of the working space the pressure can reach millions of bars. No kind of material would resist that pressure. But 100 mm outside the center, the peak pressure is much lower and non destructive for steel.

FIG. 15 shows a more detailed view of the center 6 of the working space. The inlet tube 28 is in fluid connection with the conditioner where the desired content of gas is added. The tip 30 of tube 28 has a conical shape to provide a slim fluid jet 33 towards the center C and the opposite tube 29, which is also in fluid connection with the conditioner as shown in FIG. 1. The end of tube 29 has also a conical shape 31 to collect the jet 33. Two streamlines 32 illustrate the jet between the ends of the two tubes. Small deuterium-tritium gas bubbles added in the conditioner will pass continuously through the center 6 of the working space. When a high-pressure wave, e.g., 2 millions bars arrives at the center C, the bubbles will be compressed and the nuclear fusion starts.

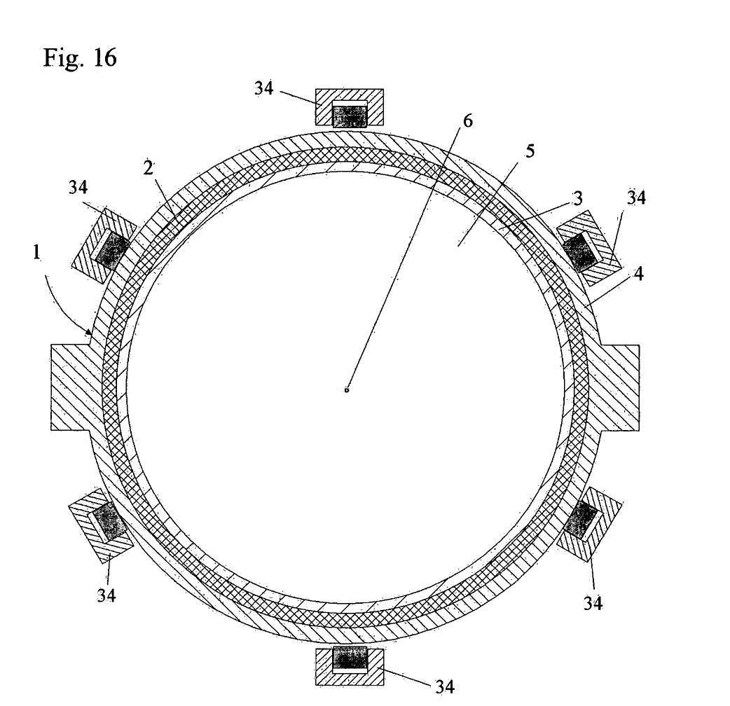

FIG. 16 shows a cross section of the fusion reactor 1 comprising the inner wall 3 the actuator 2, the outer wall 4 and the working fluid 5. Due to tolerances in manufacturing and differences of the used materials as well as deformations by its own weight, the actuator may not be capable of generating a perfect spherical pressure wave, which focuses in the center 6 of the working space. To make small shape adjustments on the outer wall of the working space hydraulic piston-barrel elements 34 are used to compensate the deformations mentioned before. The control and power unit will control these piston-barrel elements.

A working space with a diameter of 2 m may be deformed on the bottom (north pole by comparing with our earth) by its own weight for 0.5 mm. To optimize the focus qualities the working space could be compressed around the equator by using piston barrel elements for also 0.5 mm to get the perfect shape.

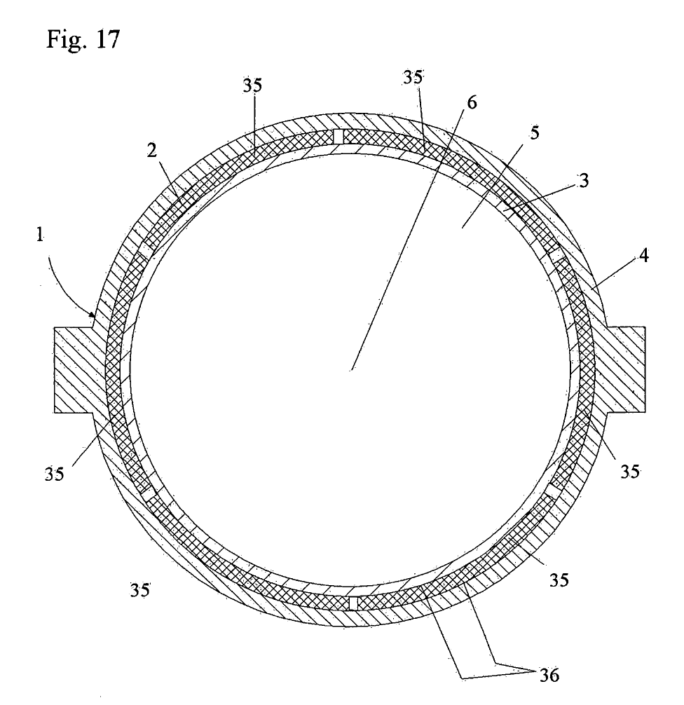

FIG. 17 shows a cross section of the fusion reactor 1 comprising the inner wall 3 the actuator 2, the outer wall 4 and the working fluid 5. In this implementation, to make adjustments, the actuator 2 is segmented in different segments 35 where each segment has its own control input 36. The control and power unit will control these segments in a way that each segment is provided a signal with an individual time delay to improve focusing the pressure wave. For example, the sound of speed of water is approximately 1400 m/s or 1.4 mm/□s. To compensate the same amount of 0.5 mm deformation of the previous example, the control signal for the piezo actuator (closest to the center of the working space) will be delayed by approximately 0.3 □s seconds.

While the invention has been described in terms of embodiments, those skilled in the art will recognize that the invention can be practiced with modifications and in the spirit and scope of the appended claims.

1. A fusion reactor assembly, comprising:
a substantially spherical body adapted to contain working fluid in a working space which is closed to ambient;
at least one actuator contained by the substantially spherical body to generate at least one pressure wave in the working fluid; and
means for amplifying the at least one pressure wave in the working fluid such that an amplified pressure wave deforms the actuator to generate electrical energy.

2. A fusion reactor as recited in claim 1, wherein the at least one actuator is a piezo material capable to converting compressive force into electrical energy.

3. A fusion reactor of claim 2, wherein the at least one actuator is segmented.

4. A fusion reactor of claim 3, wherein the segments allow contraction of the at least one actuator in a tangential direction.

5. A fusion reactor of claim 3, wherein each of the segments has a hexagonal shape.

6. A fusion reactor of claim 3, wherein the segments have a gap therebetween.

7. A fusion reactor of claim 3, wherein the segments are separately controlled with time delays to improve a focus of the pressure wave in a center of the working space.

8. A fusion reactor of claim 1, wherein the substantially spherical body includes an inner wall and an out wall, the at least one actuator is housed between the inner wall and the outer wall.

9. A fusion reactor of claim 1, wherein the at least one actuator is at least one magneto restriction actuator which has a space between an inner wall and an outer wall of the substantially spherical body.

10. A fusion reactor of claim 1, wherein the at least one actuator is a solenoid actuator and the solenoid actuator is connected with an outer wall and an inner wall of the substantially spherical body and between poles.

11. A fusion reactor of claim 1, wherein the working fluid contains deuterium-tritium gas in solution.

12. A fusion reactor of claim 1, wherein the amplifying means includes at least one deuterium-tritium gas bubble compressed by the pressure wave to generate the amplified pressure wave.

13. A fusion reactor of claim 12, wherein the at least one deuterium-tritium gas bubble is provided by a fluid jet through a center of the working space.

14. A fusion reactor of claim 12, wherein the at least one deuterium-tritium gas bubble includes oxygen.

15. A fusion reactor of claim 1, wherein the amplifying means generates a negative pressure wave compared to residual pressure to generate deuterium-tritium gas bubbles in a center of the working space.

16. A fusion reactor of claim 1, wherein the at least one actuator generates a pressure wave to compensate for deformations of a previous generated pressure wave caused by pressure dependent sound speeds of the working fluid.

17. A fusion reactor of claim 1, wherein the at least one actuator actuates with natural frequency or a multiplicity of the natural frequency of the working fluid and amplifies the at least one pressure wave step by step until pressure spikes in a center of the working space start a nuclear fusion.

18. A fusion reactor of claim 1, wherein the working fluid is water.

19. A fusion reactor of claim 1, wherein the working fluid is pressurized to a constant level of about 0.05 Mpa to 5 Mpa.

20. A fusion reactor of claim 1, wherein one of (i) an outer wall of the substantially spherical body is deformed to optimize a focus of the at least one pressure wave in a center of the working space and (ii) hydraulic piston-barrel elements optimize a focus of the at least one pressure wave in the center of the working space.

21. A fusion reactor of claim 1, wherein one or more pressure sensors sense and provide control feedback to a control and power unit to control a focus of the at least one pressure wave in the center of the working space.

22. A fusion reactor of claim 1, further comprising:
a control and power unit activating the at least one actuator to generate the at least one pressure wave in the working fluid; and
a conditioning system providing stable pressure and temperature conditions of the working fluid,
wherein the control and power unit uses one or more pressure sensors, a pressure pump and an external reservoir to control residual pressure of the working fluid within the working space.

23. A fusion reactor of claim 1, further comprising:
a control and power unit activating the at least one actuator to generate the at least one pressure wave in the working fluid; and
a conditioning system providing stable pressure and temperature conditions of the working fluid,
wherein the control and power unit uses one ore more temperature sensors, a secondary fluid circuit with a pump, a heat exchanger and the conditioner to control the temperature of the working fluid within the working space.

24. A fusion reactor of claim 23, wherein the conditioner provides at least one of (i) calibrated deuterium-tritium gas bubbles for the amplifying means or a predetermined amount of soluble deuterium-tritium gas in the working fluid and (ii) removes helium from the working fluid.

25. A fusion reactor of claim 1, further comprising a power unit to apply an electrical voltage to connectors of the substantially spherical body, the electrical voltage provides an electrical field which lengthens the at least one actuator to begin generating a pressure within the working space.

26. A fusion reactor of claim 25, wherein the at least one actuator compresses an inner wall of the working space with a speed of approximately 2 m/s.

27. A fusion reactor of claim 1, wherein an outer wall of the substantially spherical body prevents deformations from stress and an inner wall of the substantially spherical body has flexible wall thickness.

28. A fusion reactor of claim 1, wherein the amplifying means includes gas bubbles in a center of the working space provided by one or more inlet tube located in a radial arrangement to the working space which are compressed by the pressure wave.

29. A fusion reactor of claim 28, wherein the one or more inlet tube has a conical shape tip.

30. A fusion reactor of claim 1, further comprising means for activating the actuator to generate an initial pressure wave in the working fluid.

31. A fusion reactor assembly, comprising:
a substantially spherical body having an inner wall and an outer wall, the inner wall adapted to contain working fluid in a working space which is closed to ambient;
at least one actuator contained between the inner wall and the outer wall, the at least one actuator generating at least one pressure wave in the working fluid;
a control and power unit activating the at least one actuator to generate the at least one pressure wave in the working fluid;
a conditioning system providing stable pressure and temperature conditions of the working fluid; and
means for supplying a gas bubble into the center of the substantially spherical body which intersects with the at least one pressure wave, wherein
the at least one pressure wave compresses the gas bubble which, in turn, amplifies the at least one pressure wave, and
the amplified pressure wave reflects on the inner wall and deforms the actuator to generate electrical energy.

32. A fusion reactor of claim 31, wherein the at least one actuator is a piezo material.

33. A fusion reactor of claim 32, wherein the piezo material is segmented, the segments allow contraction of the at least one actuator in a tangential direction and are separately controlled with time delays to improve a focus of the pressure wave in a center of the working space.

34. A fusion reactor of claim 31, wherein the at least one actuator is one of (i) a magneto restriction actuator which has a space between the inner wall and the outer wall of the substantially spherical body and (ii) a solenoid actuator and the solenoid actuator is connected with the outer wall and the inner wall of the substantially spherical body and between poles.

35. A fusion reactor of claim 31, wherein the working fluid contains at least deuterium-tritium gas in solution.

36. A fusion reactor of claim 31, wherein the amplifying means includes at least deuterium-tritium bubbles compressed by the at least one pressure wave to generate the amplified pressure wave.

37. A fusion reactor of claim 31, wherein the amplifying means generates a negative pressure wave compared to residual pressure to generate deuterium-tritium bubbles in a center of the working space.

38. A fusion reactor of claim 31, wherein the at least one actuator actuates with natural frequency or a multiplicity of the natural frequency of the working fluid and amplifies the at least one pressure wave step by step until pressure spikes in a center of the working space start a nuclear fusion.

39. A fusion reactor of claim 31, wherein one of (i) the outer wall is deformed to optimize a focus of the pressure wave in the center of the working space and (ii) hydraulic piston-barrel elements optimize a focus of the pressure wave in the center of the working space, and one or more pressure sensors sense and provide control feedback to the control and power unit to control a focus of the pressure wave in the center of the working space.

40. A fusion reactor of claim 31, wherein:
the control and power unit uses one or more pressure sensors, a pressure pump and an external reservoir to control residual pressure of the working fluid within the working space, and
the control and power unit uses one ore more temperature sensors, a secondary fluid circuit with a pump, a heat exchanger and the conditioner to control the temperature of the working fluid within the working space.

41. A fusion reactor of claim 40, wherein the conditioner provides at least one of (i) calibrated deuterium-tritium gas bubbles for the amplifying means or a predetermined amount of soluble deuterium-tritium gas in the working fluid and (ii) removes helium from the working fluid.

42. A fusion reactor of claim 31, wherein the amplifying means includes gas bubbles in a center of the working space provided by one or more inlet tubes located in a radial arrangement to the working space which are compressed by the pressure wave.

43. A method of providing a fusion reaction in a substantially spherical body closed to ambient to generate electricity, the method comprising the steps of:
providing a working fluid;
providing a gas bubble in the working fluid;
generating a pressure wave in the working fluid that intersects with the gas bubble;
compressing the gas bubble with the pressure wave to increase a temperature and pressure of the gas bubble creating a thermal reaction and triggering a fusion reaction of material comprising the gas bubble; and
amplifying the pressure wave which then deforms an actuator material to generate electricity.

44. The method of claim 43, wherein the gas bubble is composed of at least deuterium and tritium and the working fluid is at least water.
